(19) United States
(12) Patent Application Publication
(10) Pub. No.: US 2017/0216642 A1
(43) Pub. Date: Aug. 3, 2017

(54) HORIZONTAL SIDEWALL SPRINKLER

(71) Applicant: The Reliable Automatic Sprinkler Co., Inc., Liberty, SC (US)

(72) Inventors: George S. Polan, Liberty, SC (US); Juan Jimenez, Liberty, SC (US)

(21) Appl. No.: 15/500,841

(22) PCT Filed: Aug. 3, 2015
(86) PCT No.: PCT/US2015/043498

§ 371 Date: Jan. 31, 2017

Related U.S. Application Data
(60) Provisional application No. 62/032,389, filed on Aug. 1, 2014.

(51) Int. Cl. A62C 37/09; A62C 31/02

(52) U.S. Cl. CPC A62C 37/09; A62C 31/02; A62C 37/11

(57) ABSTRACT

A horizontal sidewall sprinkler is provided which includes a sprinkler body having an inlet passage for supply of a fluid and an outlet, the outlet being closed by a sealing assembly prior to actuation of the sprinkler. The sprinkler further includes a sleeve body secured to the sprinkler body and a yoke substantially spanning a width of the sleeve body, the yoke urging a load screw against a surface of the sealing assembly facing an occupancy, and being held in place prior to actuation of the sprinkler by two levers that are joined by a soldered link. A slide plate is located near an inner wall of the sprinkler body facing the occupancy prior to actuation of the sprinkler. According to one example embodiment, a frame or two guide pins are provided for bearing and supporting a deflector. The deflector is positioned between the load screw and the sealing assembly thereby obstructing a flow of fluid from the outlet upon actuation of the sprinkler. A spring is provided in the sprinkler body, between the inner wall of the sprinkler body and pressing (1) the slide plate and (2) the frame or the two guide pins away from the inner wall. Upon actuation of the sprinkler, the levers, the yoke and the load screw are forced out of and away from the sprinkler by the force of the fluid; the spring forces the slide plate outward from the inner wall; and the force of the fluid moves the deflector away from the slide plate to a position for delivery of the fluid to the protected area.

### RELATED APPLICATION

This application claims the benefit of U.S. Provisional Patent Application No. 62/032,389, filed Aug. 1, 2014, the contents of which are hereby incorporated by reference as if fully stated herein.

### BACKGROUND

### Field

The present disclosure relates to a horizontal sidewall fire protection sprinkler.

Fire protection sprinklers conventionally are connected to a conduit to receive pressurized fire-extinguishing fluid, such as water. A typical sprinkler has a base with a threaded portion for connection to the conduit and an output orifice to output the fluid to provide fire control and/or suppression. The output orifice is sealed by a seal cap, which is held in place by a release mechanism. The release mechanism is designed to release the cap under predetermined conditions, thereby initiating the flow of fire-extinguishing fluid. A typical release mechanism includes a thermally-responsive element, e.g., a frangible bulb or a fusible link, and may include a latching mechanism.

Fire protection sprinklers may be mounted to a wall, a certain distance below the ceiling, which is referred to as a “horizontal sidewall” configuration. Horizontal sidewall sprinklers have an output orifice that is oriented so that the fluid is output horizontally and sprays onto an area to be protected that is primarily in front of the sprinkler. Horizontal sidewall sprinklers are particularly useful in applications in which overhead piping is not easily installed, e.g., in residential applications including hotels, dormitories, and private residences. Horizontal sidewall sprinklers may also be used in commercial applications, e.g., office buildings and retail spaces.

Horizontal sidewall sprinklers may project from the finished surface of a wall or horizontal sidewall sprinklers may be recessed into a wall so that only a portion of the sprinkler projects beyond the finished surface of the wall. Alternatively, horizontal sidewall sprinklers may be designed to be concealed within a wall, as, for example, by a cover plate, prior to actuation of the sprinkler.

Underwriters' Laboratories® Standard 199 (UL 199) specifies testing requirements for horizontal sidewall sprinklers used in commercial applications; tests verify such features as the ability of the horizontal sidewall sprinkler to evenly distribute fluid to a horizontal plane above the floor of a test room and to distribute fluid to walls of a test room. Underwriters' Laboratories® Standard 1626 (UL 1626) specifics testing requirements for horizontal sidewall sprinklers used in residential applications; tests verify such features as the ability of the tested horizontal sidewall sprinkler to evenly distribute fluid to a horizontal place above the floor of the test room and to distribute at least 20 percent of the fluid discharged from the tested horizontal sidewall sprinkler to the walls of the test room, with each wall receiving a portion of the fluid that is proportional to a ratio of the length of the wall to the perimeter of the room. The size of the test room used for the UL 1626 fluid distribution tests is based on the coverage area of the horizontal sidewall sprinkler, where the coverage area consisting of a rectangle with a length perpendicular to the surface of the wall in which the horizontal sidewall sprinkler is installed and a width parallel to the surface of the wall in which the horizontal sidewall sprinkler is installed.

### SUMMARY

In one example embodiment described herein, a horizontal sidewall fire protection sprinkler is provided which includes a sprinkler body having an inlet passage for supply of a fluid and an outlet. The outlet is closed by a sealing assembly prior to actuation of the sprinkler. The horizontal sidewall sprinkler further includes a sleeve body secured to the sprinkler body and a yoke substantially spanning a width of the sleeve body. The yoke urges a load screw against a surface of the sealing assembly facing the interior of the occupancy being protected, and is held in place prior to actuation of the sprinkler by two levers that are joined by a soldered link. A slide plate is located near an inner wall of the sprinkler body facing the occupancy prior to actuation of the sprinkler. The slide plate has a central aperture for fitting over the inlet passage. A frame or two guide pins are provided for bearing and supporting a deflector. The deflector is positioned between the load screw and the sealing assembly thereby obstructing a flow of fluid from the outlet upon actuation of the sprinkler. A spring is provided in the sprinkler body, between the inner wall of the sprinkler body and pressing (1) the slide plate and (2) the frame or the two guide pins away from the inner wall. Upon actuation of the sprinkler, the levers, the yoke and the load screw are forced out of and away from the sprinkler by the force of the fluid; the spring forces the slide plate outward from the inner wall; and the force of the fluid moves the deflector away from the slide plate to a position for delivery of the fluid to the protected area.

According to another example embodiment, the slide plate has two additional apertures that receive towers, each tower housing one of the two guide pins. In this example embodiment, the spring may further force the guide pins to extend from the towers after actuation of the sprinkler.

In another example embodiment, the sealing assembly comprises a spring washer seated at the outlet, and a closure element received in the washer and sealing the outlet. Here, the seal is kept closed prior to actuation of the sprinkler. In some example embodiments, the closure element has an oblique lower surface in part.

According to yet another example embodiment, the yoke is self-centering and self-seating on a retaining flange of the sleeve body, having terraced tabs on both ends of the yoke. A top one of the tabs serves as a vertical seating medium, a middle one of the tabs serves as a horizontal centering medium with the inner diameter of the flange, and a bottom one of the tabs serves as a load bearing medium for the soldered link levers.

In an additional example embodiment, the horizontal sidewall sprinkler further includes a diffuser including a convex solid portion located with its center on an axis of fluid passage in the sprinkler body. Prior to actuation of the sprinkler the diffuser transmits the force from the load screw to the seal assembly, and upon actuation of the sprinkler, the fluid strikes the convex solid portion of the diffuser. The diffuser comprises a horizontally extending upper planar portion extending above the axis of the fluid passage, and the fluid passes through the diffuser through an aperture provided above the convex portion and below the upper planar portion. The diffuser further comprises additional apertures provided in a vertical portion of the deflector provided downstream from the convex portion.

According to yet another example embodiment, the frame may be wishbone-shaped, having two arms being attached to the slide plate, and a top portion of the frame opposite the two arms is attached to the deflector.

In one example embodiment, the arms of the frame are substantially the same size as side of the deflector parallel to the arms. In this example embodiment, the sprinkler, prior to actuation, fits in a roughly 3-1/2-inch deep space formed by nominal 2 inch by 4 inch studs in the wall.

Various embodiments of the sprinkler may be a residential sidewall sprinkler, a sidewall standard spray sprinkler, or an extended coverage sidewall spray sprinkler. Also, the occupancy to be protected can be a residential occupancy, a light hazard occupancy, or an ordinary hazard occupancy as defined by NFPA 13, Standard for the Installation of Sprinkler Systems.

The sprinkler can have a nominal K-factor of about 4.2 gpm/psi^{1/2}, 5.6 gpm/psi^{1/2}, or 8.0 gpm/psi^{1/2}.

In some example embodiments, the sprinkler can provide standard spacing as defined by NFPA 13. In other example embodiments, the sprinkler can provide coverage area of equal to or greater than 8 feet by 8 feet and up to and including 16 feet by 20 feet. In other example embodiments, the sprinkler can provide a coverage area of equal to or greater than 8 feet by 8 feet and up to and including 18 feet by 22 feet or 16 feet by 24 feet.

In some example embodiments, a minimum flow rate of the sprinkler is at least 12 gallons per minute (gpm) and a minimum pressure of the sprinkler is at least 8.2 pounds per square inch (psi). In other example embodiments, a minimum flow rate of the sprinkler is at least 26 gpm and a minimum pressure of the sprinkler is at least 10.6 psi.

Further features and advantages, as well as the structure and operation of various embodiments herein, are described in detail below with reference to the accompanying drawings.

### BRIEF DESCRIPTION OF THE DRAWINGS

The teachings claimed and/or described herein are further described in terms of example embodiments. These example embodiments are described in detail with reference to the drawings. These embodiments are non-limiting example embodiments, in which like reference numerals represent similar structures throughout the several views of the drawings and wherein:

FIG. 1A is a top view of a horizontal sidewall fire protection sprinkler according to an example embodiment herein, and FIG. 1B is a sectional view of the horizontal sidewall fire protection sprinkler shown in FIG. 1A.

FIG. 1C is a top view of a horizontal sidewall fire protection sprinkler according to another example embodiment herein, and FIGS. 1D and 1E are sectional views of the horizontal sidewall fire protection sprinkler shown in FIG. 1C.

FIGS. 2A to 2C are a top view, sectional view, and isometric view, respectively, of a sub-assembly of a diffuser, deflector, pins and slide plate of the horizontal sidewall fire protection sprinkler shown in FIGS. 1C to 1E.

FIGS. 3A to 3C are a top view, sectional view, and detail view, respectively, of a sub-assembly of the diffuser and the deflector shown in FIGS. 2A to 2C.

FIGS. 4A to 4E are various perspective views of the deflector shown in FIGS. 3A to 3C.

FIGS. 5A to 5D are a top view, side view, sectional view, and detail view of the diffuser shown in FIGS. 3A to 3C.

FIG. 6A is a top view of a horizontal sidewall fire protection sprinkler according to an additional example embodiment herein, and FIGS. 6B and 6C are sectional views of the horizontal sidewall fire protection sprinkler shown in FIG. 6A.

FIGS. 7A and 7B are a top view and side view, respectively, of a sub-assembly including a deflector, frame and slide plate of the horizontal sidewall fire protection sprinkler shown in FIGS. 6A to 6C, and FIGS. 7C and 7D are sectional views of the sub-assembly shown in FIGS. 7A and 7B.

FIGS. 8A to 8F are various views of the deflector shown in FIGS. 7A to 7D.

FIG. 9A is a top view of a horizontal sidewall fire protection sprinkler according to yet another example embodiment herein, and FIGS. 9B and 9C are sectional views of the horizontal sidewall fire protection sprinkler shown in FIG. 9A.

FIGS. 10A and 10B are a top view and side view of a sub-assembly including a deflector, frame and slide plate of the horizontal sidewall fire protection sprinkler shown in FIGS. 9A to 9C, and FIGS. 10C and 10D are sectional views of the sub-assembly shown in FIGS. 10A and 10B.

FIGS. 11A to 11F are various views of the deflector shown in FIGS. 10A to 10D.

FIGS. 12 to 14 are isometric views of the horizontal sidewall fire protection sprinkler shown in FIGS. 1A and 1B in different stages of deployment.

Any reference numeral that appears in different figures represents the same element in those figures, even if that element is not described separately with respect to each figure.

### DETAILED DESCRIPTION

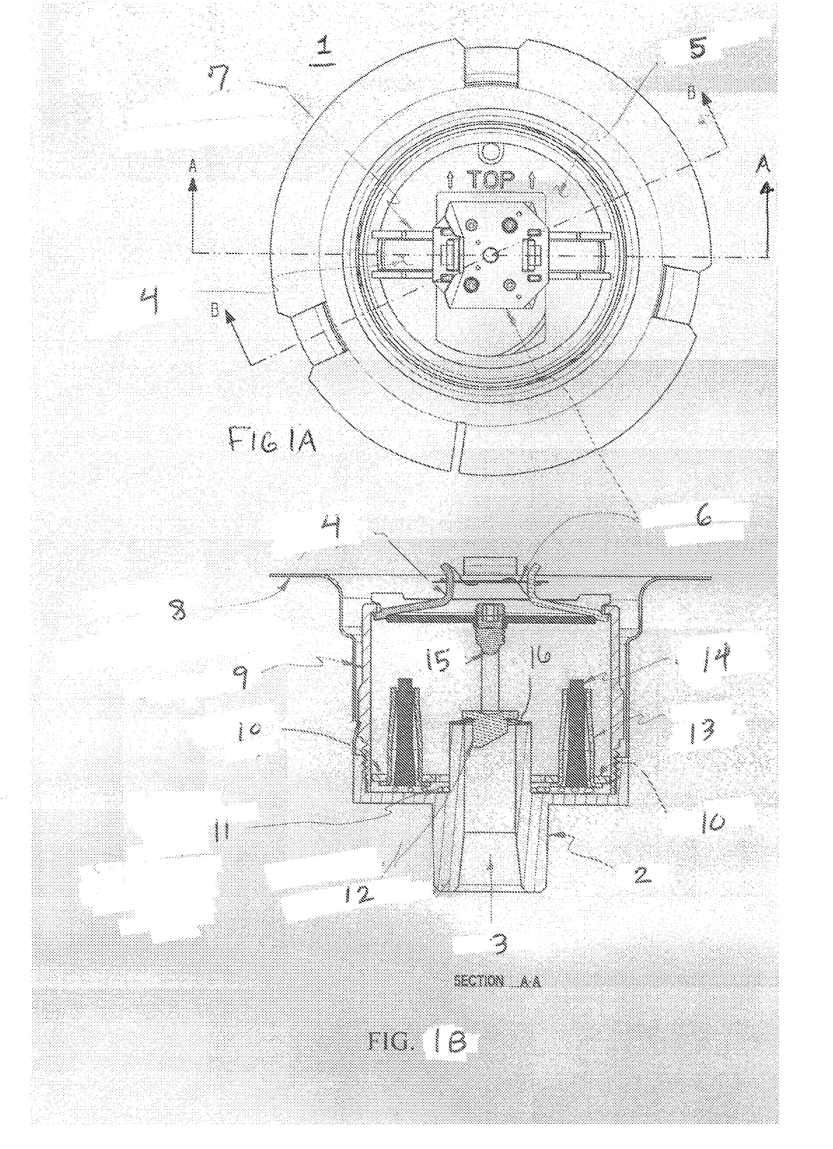

An actuation structure and mechanism of a horizontal sidewall sprinkler according to one example embodiment is shown in FIGS. 1A and 1B. The horizontal sidewall sprinkler is preferably installed as a concealed sprinkler and may be constructed in different sizes, most preferably with a K-factor (a term known in the art) of about 4.2, or 5.6, or 8.0 gpm/psi^{1/2} or less or more; implementations having K factors from at least 2 to 25 gpm/psi^{1/2} or more are within the scope of the invention. The horizontal sidewall sprinkler, according to this example embodiment, may be useful in light hazard and ordinary hazard, as well as residential, applications.

As shown in FIGS. 1A and 1B, a horizontal sidewall fire protection sprinkler 1 has a sprinkler body 2 provided with an inlet passage 3 for connection to a conduit (not shown) for supplying pressurized fire-extinguishing fluid such as water. The outlet from that passage 3 is closed by a seal assembly having a spring washer 16 seated at the outlet, and a closure element 12 received in the washer 16 and sealing the outlet. As shown the closure element 12 has an oblique lower surface in part (it should be noted that most of the figures that form part of this disclosure show the sprinkler with its outlet pointing up; in fact, the outlet would be oriented for output water horizontally; nonetheless; also, all such references (except where otherwise stated) to up and down, or top and lower, etc., are to the orientation in the drawing figure being referred to, and not to the orientation in the sprinkler when installed). The seal is kept closed prior to actuation of the sprinkler as described in more detail below.

The sprinkler further has a sleeve body 9 secured to the sprinkler body 2, for example by means of threads. A slide plate 10 described below is located near the bottom of the sprinkler body 2 (in the unactuated state), and has a central aperture to allow it to fit over the inlet passage 3, as shown in FIG. 1B. Two additional apertures provided in the slide plate 10 receive towers 13, each of which is at least approximately cylindrical in its lower portion, and conical in its upper portion. The towers 13 each house a guide pin 14, and the two guide pins 14 bear and support a deflector (not shown in FIG. 1B).

A yoke 7 spans most of the width of the interior of the sleeve body 9, and urges a load screw 15 downward against the upper surface of the closure seal 12. The yoke 7 is held in place prior to actuation by two levers 4 that are joined by a soldered link 6. A spring 11, for example, a conical compression spring, is provided in the sprinkler body 2, between the lower wall thereof and the slide plate 10, and presses the slide plate 10 and guide pins 14 upward. The spring 11 is shown at a flat compressed state.

In the complete sprinkler, which is shown, for example, in the embodiment discussed below in connection with FIGS. 1C to 1E, the deflector is positioned between the load screw 15 and the closure seal 12 when the sprinkler 1 is unactuated. The load screw 15, thus, also presses the slide plate 10 toward the inner wall of the sprinkler body 2 (the bottom of the body, in the orientation of the drawings).

Fusion of the soldered link 6 results, in a fashion familiar to those in the art, in the release of the levers 4, and results in the levers 4, the yoke 7 and the load screw 15 being forced out of and away from the sprinkler 1 by the force of the fluid. At this time, also, the force of the fluid moves the deflector away from the slide plate, and the conical spring 11 forces the slide plate 10 outward from the wall (up in the drawing), and forces the guide pins 14 to extend from the towers 13, moving the deflector to the proper position to deliver the fluid to the protected area.

It is not preferred in this example embodiment to use longer guide pins, making them stationary by directly attaching them to the slide plate; nonetheless it does not depart from the broad scope of the embodiment to do so.

A flat concealed cover plate (not shown) is used with the sprinkler 1.

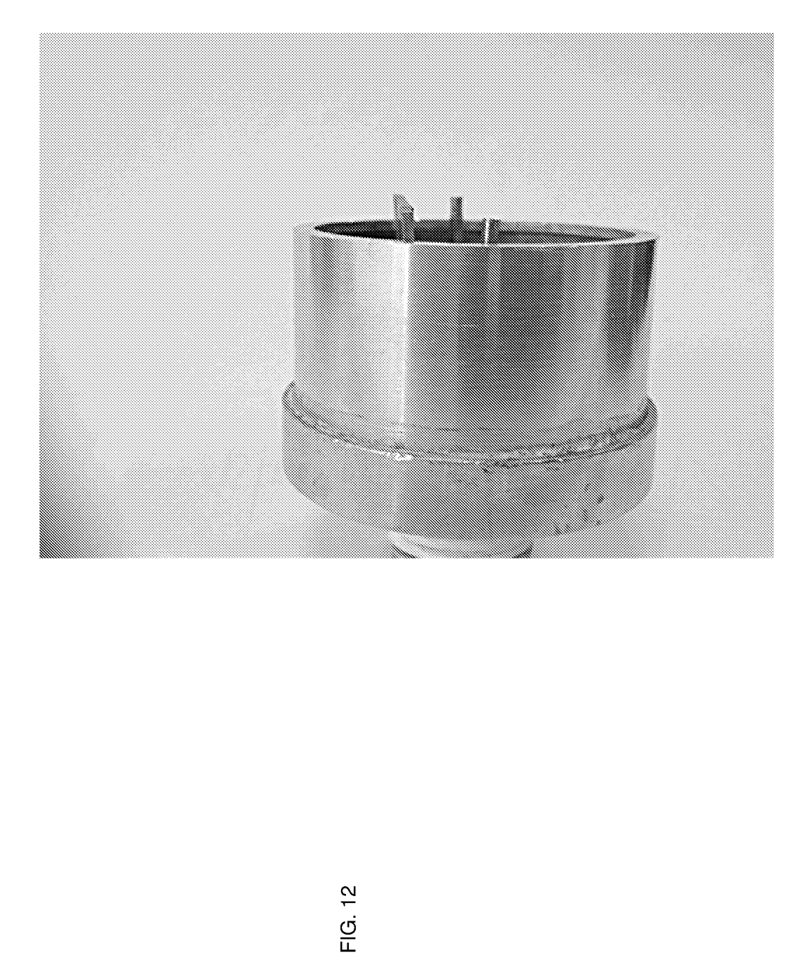

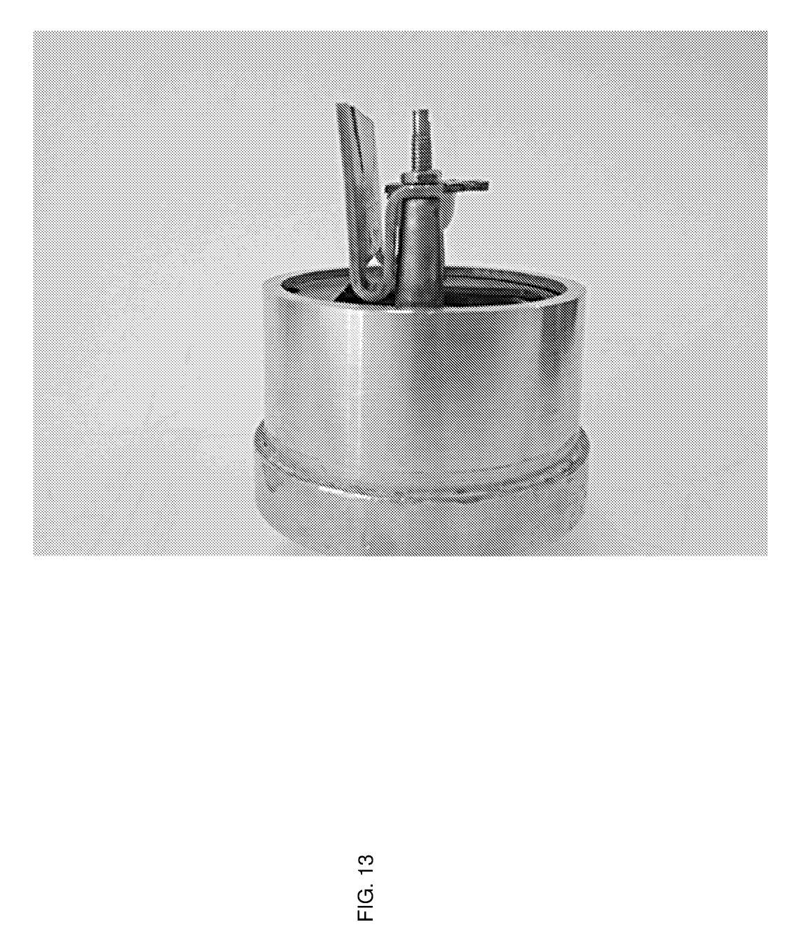

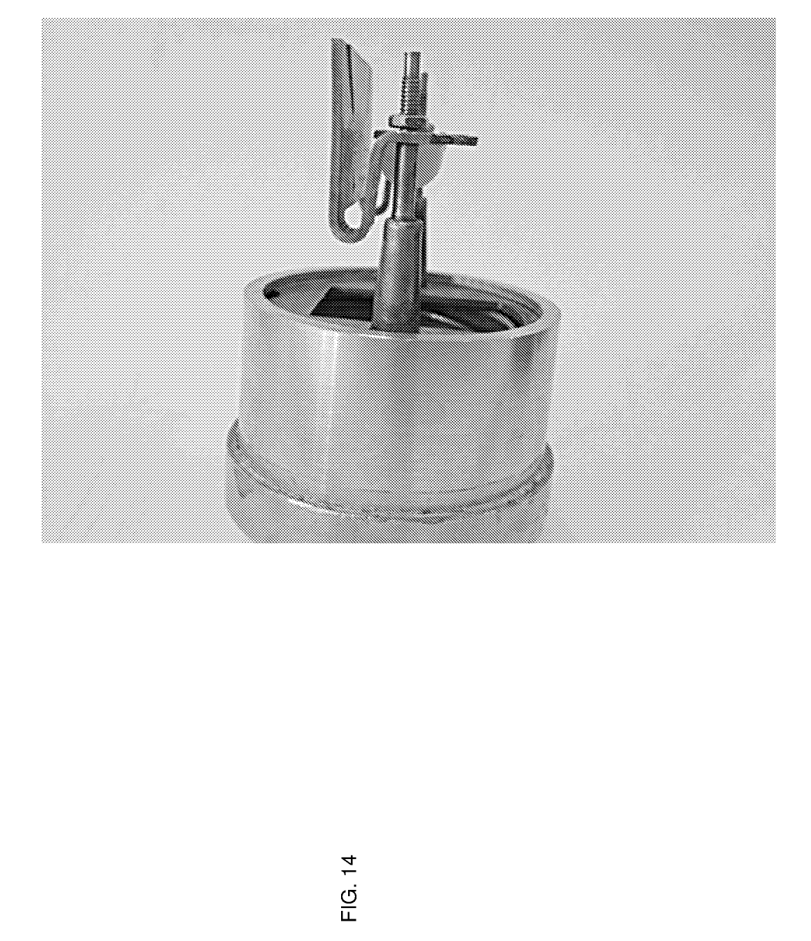

This example embodiment provides for two phases of deflector deployment (after link activation, and yoke/levers ejection), which can be seen in FIGS. 12 to 14. FIG. 12 shows the sprinkler prior to deflector deployment, but with link/yoke and levers already ejected. FIG. 13 shows the first phase of deflector deployment (note that the deflector's leg is resting on the guide pin tower). FIG. 14 shows the second phase of deflector deployment (note that the guide pin is protruding from the tower).

This double deployment assures that the deflector achieves sufficient protrusion from the wall's face and allows water to wet adjacent corners to at least 30 inches above the floor elevation.

To further assure complete deployment of the deflector assembly the slide plate 10 is assisted by the conical spring 11, which drives the slide plate against the retaining flange on the body sleeve 9.

The sub-assembly of slide plate, guide pines, deflector and yoke, as discussed in the arrangement of this example embodiment, can provide the following advantageous effects: 1) The forward sliding slide plate, which allows the horizontal sidewall deflector to achieve initial protrusion from the wall's surface (see FIGS. 12 to 14). 2) The forward sliding guide pins, which when fully deployed increase the deflector's protrusion from the wall sufficiently to reduce back wall water wash to a satisfactory level. The guide pins are retained by the frame arms, and both interface with each other via the taper-taper feature disclosed in common-assigned U.S. Pat. No. 6,554,077 (incorporated herein by reference).

Furthermore, the yoke 7 is self-centering and self-seating within/on a retaining flange of the body sleeve 9 and has terraced tabs on both ends of the yoke, with the top one serving as a vertical seating medium, the middle one as horizontal centering medium within the inner diameter of the flange, and the bottom one as a load bearing medium for the soldered link levers. The top and middle tabs can greatly simplify the assembly process, hence reducing assembly time, and eliminating misalignment potential.

FIGS. 1C to 1E show a horizontal sidewall sprinkler 100 according to another example embodiment described herein. Similar to the sprinkler described above in connection with FIGS. 1A and 1B, the sprinkler 100 has a sprinkler body 110 provided with an inlet passage 101, the outlet from that passage 101 being closed by a seal assembly having a spring washer 120 seated at the outlet, and a closure element 140 received in the washer 120 and sealing the outlet. As shown in FIG. 1E, the closure element 140 has an oblique lower surface in part.

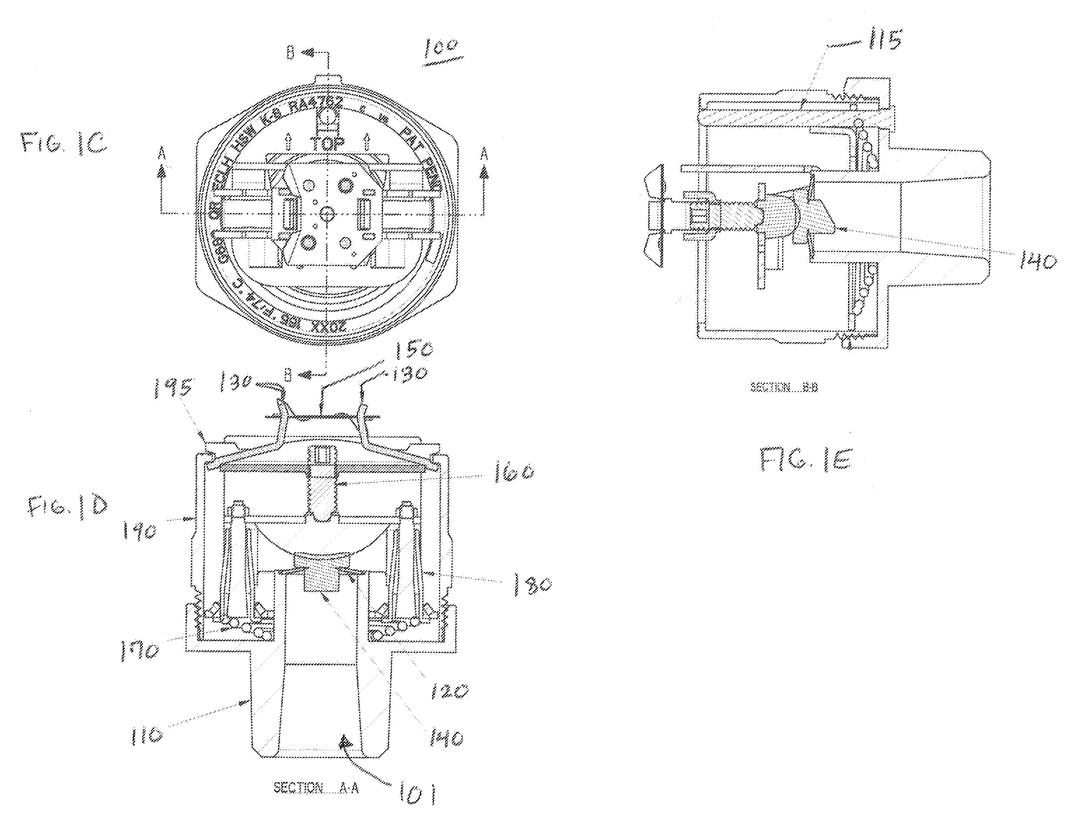

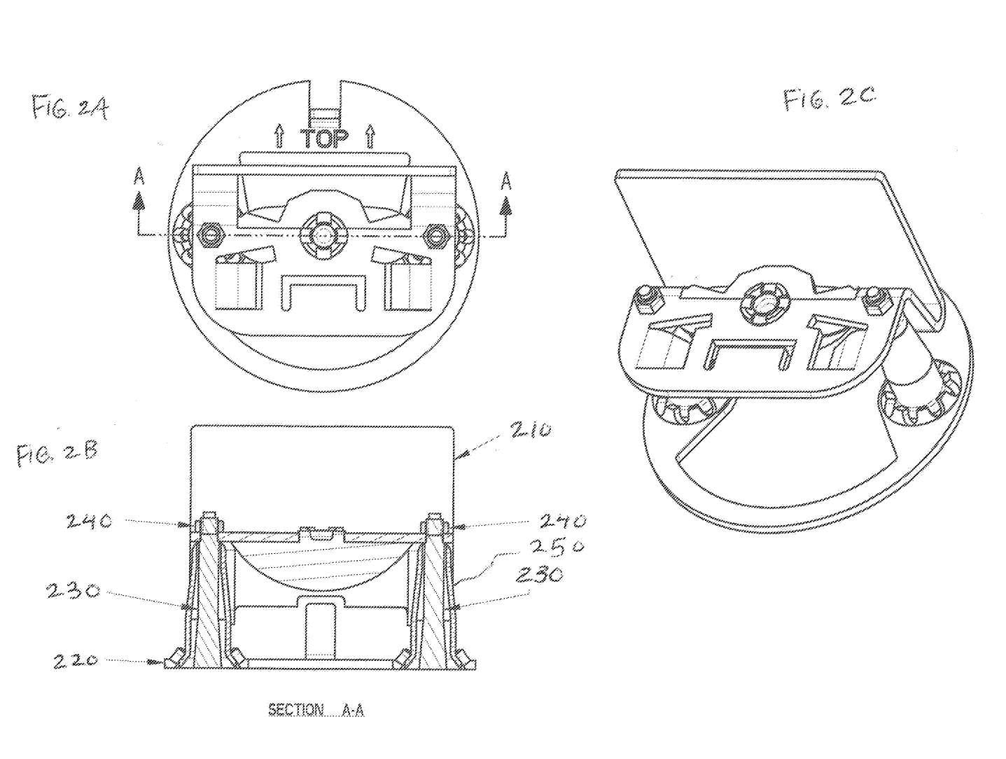

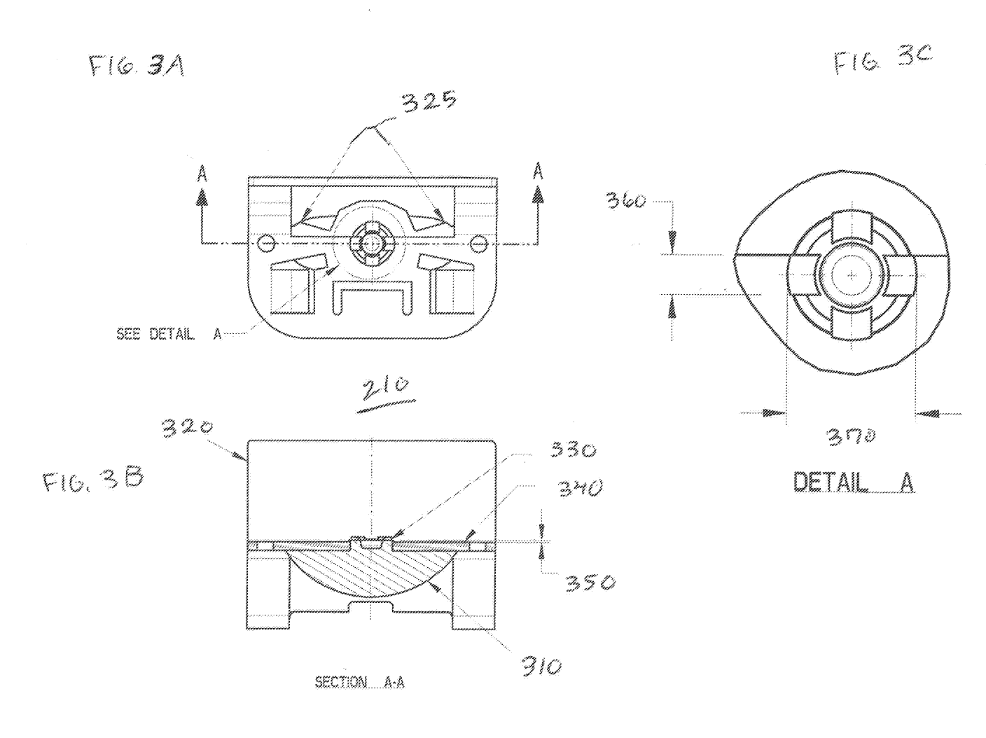

The sprinkler 100 further has a sleeve body 190 secured to the sprinkler body 110, and a sub-assembly 180 which is shown in detail in FIGS. 2A to 2C. As shown in FIG. 2B, the sub-assembly 180 includes a slide plate 220 located near the bottom of sprinkler body 110 (in the unactuated state), and has a central aperture to allow it to fit over the inlet passage 101, as shown in FIG. 1D. Two additional apertures provided in the slide plate 220 receive towers 250, each of which is at least approximately cylindrical in its lower portion, and conical in its upper portion. The towers 250 each house a guide pin 230, and the guide pins 230 bear and support a deflector/diffuser sub-assembly 210 which is described below in more detail in connection with FIGS. 3A to 3C. The sub-assembly 180 is connected to the guide pins 230 via, for example, hexagonal nuts 240.

A yoke 195 spans most of the width of the interior of the sleeve body 190, and urges a load screw 160 downward against the upper surface of the closure seal 140. The yoke 195 is held in place prior to actuation by two levers 130 that are joined by a soldered link 150. A spring 170, for example, a conical compression spring, is provided in the sprinkler body 110, between the lower wall thereof and the sub-assembly 180. The spring 170, thus, presses the slide plate 220 and guide pins 230 upward.

The deflector/diffuser assembly 210 is positioned between the load screw 160 and the closure seal 140 when the sprinkler 100 is unactuated. The load screw 160, thus, also presses the slide plate 220 toward the inner wall of the sprinkler body 110 (the bottom of the body, in the orientation of the drawings).

Fusion of the soldered link 150 results in the release of the levers 130, and results in the levers 130, the yoke 195 and the load screw 160 being forced out of and away from the sprinkler 100 by the force of the fluid. At this time, also, the conical spring 170 forces the slide plate 220 outward from the wall (up in the drawing), and forces the guide pins 230 to extend from the towers 250, moving the deflector/diffuser assembly 210 to the proper position to deliver the fluid where it is needed. The sprinkler 100 further includes a guide pin 115 which is fitted through the bottom of the sprinkler body 110 into the sleeve body 190, where the guide pin 115 helps keep the slide plate 220 aligned during deployment of the sprinkler.

Similar to the embodiment discussed above in connection with FIGS. 1A and 1B, this example embodiment also provides for two phases of deflector deployment (after link activation, and yoke/levers ejection), assuring that the deflector achieves sufficient protrusion from the wall's face and allows water to wet adjacent corners in prescribed 30″ of the floor elevation.

As shown in FIGS. 3A to 3C, the deflector/diffuser assembly 210 includes a diffuser 310 which is rigidly staked (reference numeral 330) to a deflector 320. The diffuser 310 is aligned with the deflector's tips within, for example, 0.010 inches max, as shown in FIG. 3A at reference numeral 325. A width 350 between a face 340 of the deflector and the stake 330 can be about 0.010 inches minimum. A flap 360 of the stake 330 can be about 0.08 inches and a diameter 370 of the stake can be about 0.260 to 0.265 inches.

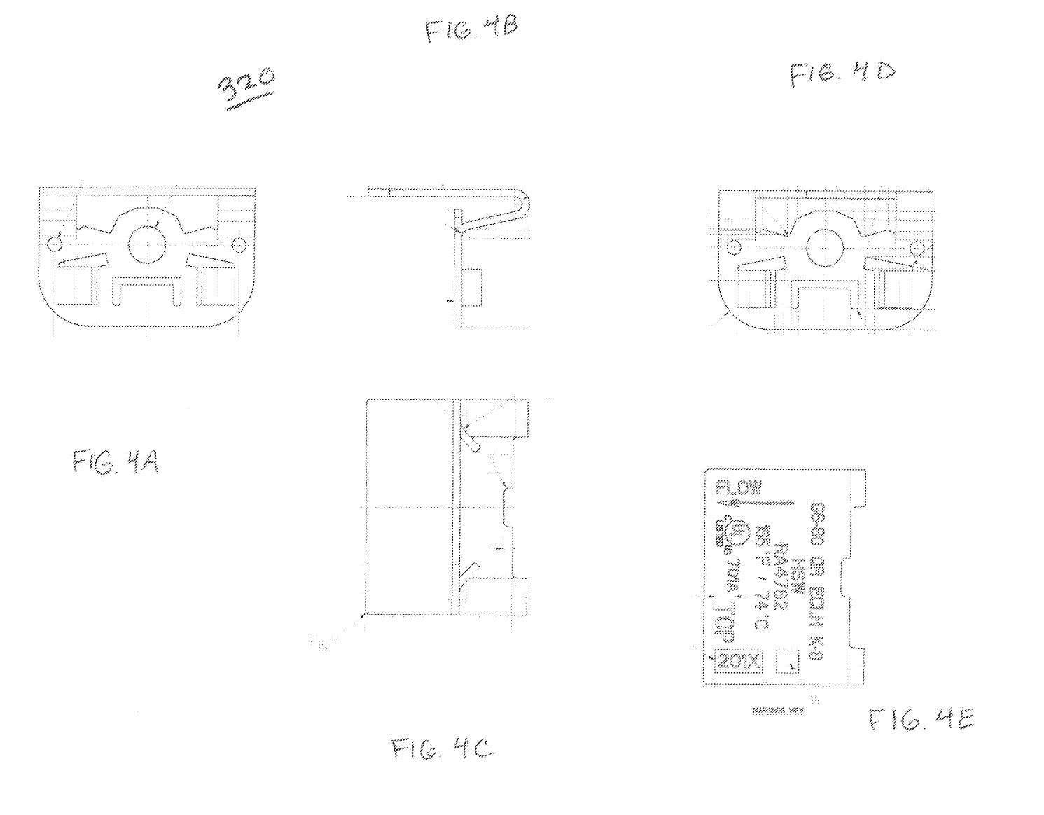

FIGS. 4A to 4E show various views of the deflector 320 shown in FIGS. 3A to 3C. The deflector 320 may if desired be identical to that used in Reliable's K-8.0 F1FR EC-9 Horizontal Sidewall Sprinkler (Bulletin 148, incorporated herein by reference), although the invention is not limited to use of that deflector.

FIGS. 5A to 5D show various views of the diffuser 310 shown in FIGS. 3A to 3C. As shown in FIGS. 5A to 5D, the diffuser 310 includes a convex solid portion (which prior to actuation transmits the force of the load screw to the closure seal). During operation of the sprinkler the fluid exiting the outlet strikes this convex portion, which thus plays an important part in ultimately providing the desired delivery of the fluid. This convex portion is located with its center on the axis of the fluid passage in the sprinkler body. A horizontally extending upper planar portion extends above the axis of the fluid passage (referring here to the actual orientation of the sprinkler when installed), and fluid can pass through the diffuser through an aperture provided above the convex portion and below the upper planar portion. Additional apertures are provided as shown in a vertical portion of the deflector provided downstream from the convex portion.

As shown in FIG. 5A, the diffuser 310 has a length 510 and a width 520. As shown in FIG. 5C, the diffuser 310 has a base with a height 550, and a top portion with height 540 and top radius 530 and bottom radius 560. The inventors have found that this structure for the diffuser provides particularly high performance, and the shape thereof is accordingly shown in its proper proportions (although the broad invention, again, is not limited to the use of this exact structure).

The oblong shape of the diffuser 310 generates a sufficiently broad water pattern that wets the far wall (including both corners) several inches higher than the UL Std 199-30″ above floor wetting criteria for ECLH type sprinklers for any room size up to 20 feet by 20 feet.

The sprinkler 100 is preferably an extended coverage sidewall spray sprinkler as defined by NFPA 13, having a nominal k-factor of about 8.0 gpm/psi^{1/2} and permitted for use in light hazard occupancies. The sprinkler 100 can obtain a coverage of 16 feet by 20 feet. Further technical details of the sprinkler 100 are provided below in Tables 1 and 2. Of course, the invention herein is not limited by the technical details provided in these tables, which are merely examples of this embodiment.

TABLE 1

| | | | | | | Maximum | Sprinkler |
|---|---|---|---|---|---|---|---|
| Nominal | | | Temperature | | Maximum | Water | Identification |
| K-factor | | Thread | Rating | | Ambient | Working | Number |
| US | Metric | Size | Sprinkler | Cover | Temperature | Pressures | (SIN) |
| 8.0 | 115 | [symbol] NPT or | 165° F. | 135° F | 100° F. | 175 PSI | RA4762 |
| | | ISO 7-R [symbol] | (74° C.) | (57° C.) | (38° C.) | (12 bar) | |

[symbol]

indicates data missing or illegible when filed

TABLE 2
Coverage Area

| Max. Installed | | Deflector | | Min. | | Min. | |
|---|---|---|---|---|---|---|---|
| Coverage Area | | to Ceiling | | Required | | Required | |
| Width × Length | | Dimension | | Flow Rate | | Pressure | |
| ft. × ft. | m × m | inches | mm | gpm | L/min | psi | bar |
| 14 × 22 | 4.3 × 6.7 | 4-6 | 102-152 | 31 | 117.3 | 15.0 | 1.03 |
| 14 × 22 | 4.3 × 6.7 | 6-12 | 152-305 | 35 | 132.5 | 19.1 | 1.3 |
| 14 × 24 | 4.3 × 7.3 | 4-6 | 102-152 | 35 | 132.5 | 19.1 | 1.3 |
| 14 × 24 | 4.3 × 7.3 | 6-12 | 152-305 | 39 | 147.6 | 23.8 | 1.6 |
| 16 × 16 | 4.9 × 4.9 | 4-12 | 102-305 | 26 | 96.4 | 10.6 | 0.7 |
| 16 × 18 | 4.9 × 5.5 | 4-12 | 102-305 | 29 | 109.8 | 13.1 | 0.9 |
| 16 × 20 | 4.9 × 6.1 | 4-12 | 102-305 | 32 | 121.1 | 16.0 | 1.1 |
| 16 × 22 | 4.9 × 6.7 | 4-12 | 102-305 | 36 | 136.2 | 20.2 | 1.4 |
| 16 × 24 | 4.9 × 7.3 | 4-12 | 102-305 | 39 | 147.6 | 23.8 | 1.6 |
| 18 × 18 | 5.5 × 5.5 | 4-12 | 102-305 | 33 | 124.9 | 17.0 | 1.2 |
| 18 × 20 | 5.5 × 6.1 | 4-12 | 102-305 | 36 | 136.2 | 20.2 | 1.4 |
| 18 × 22 | 5.5 × 6.7 | 4-12 | 102-305 | 40 | 151.4 | 25.0 | 1.7 |

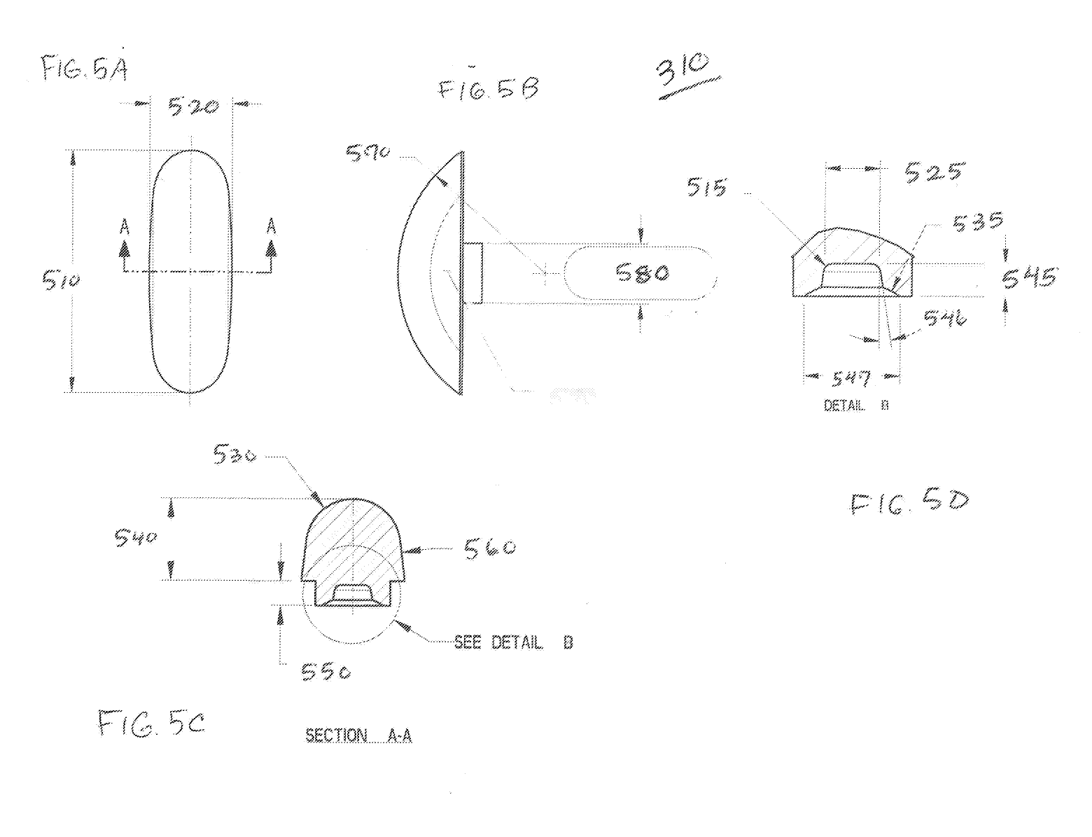

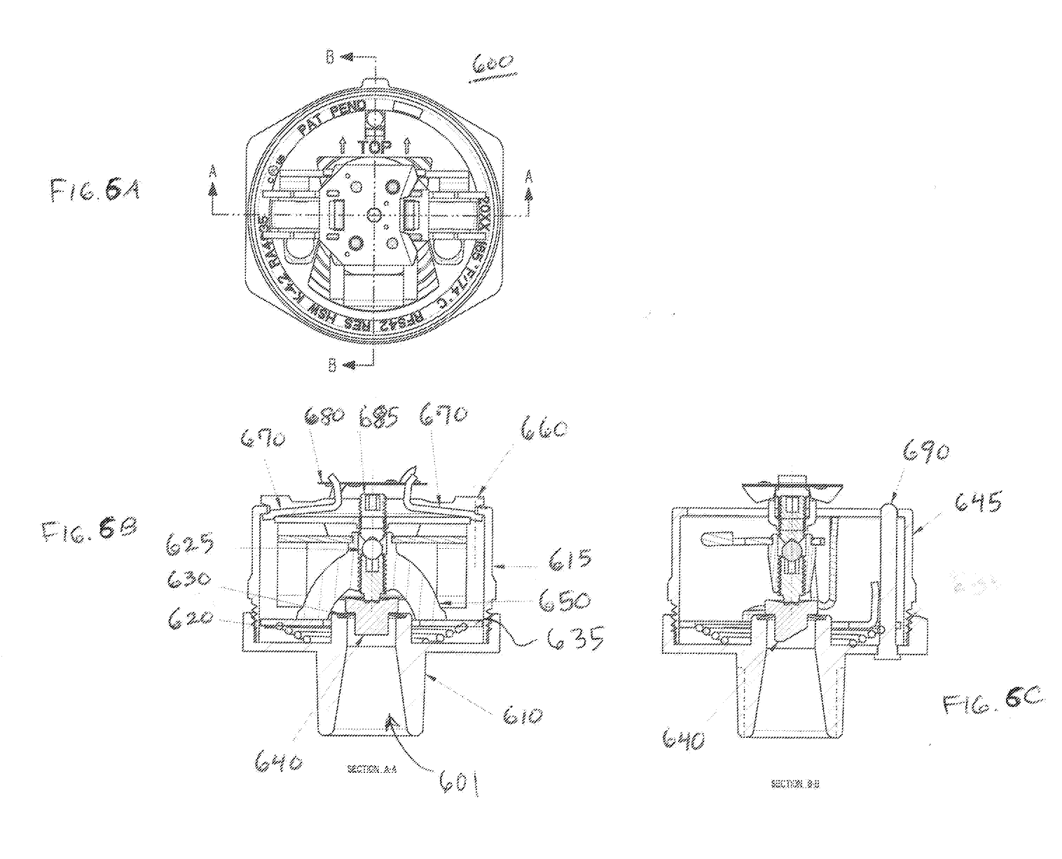

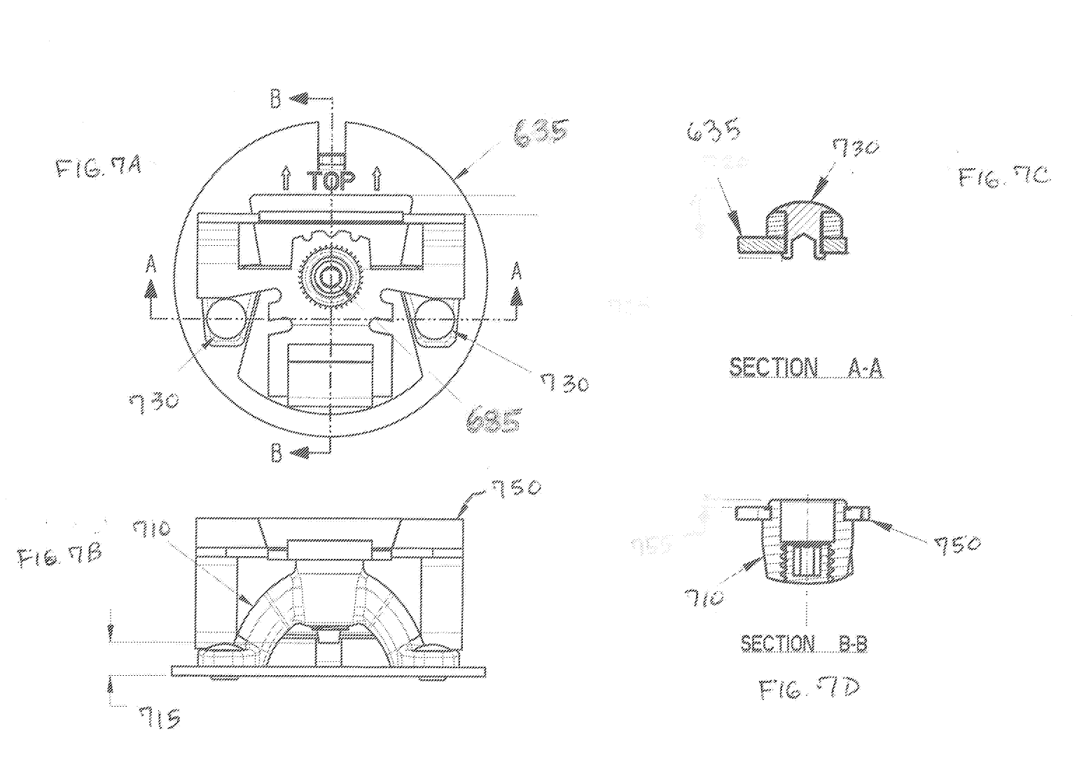

FIGS. 6A to 6C show a horizontal sidewall sprinkler 600 according to an additional example embodiment described herein. Similar to the sprinklers 1 and 100 discussed above, the sprinkler 600 includes a sprinkler body 610, an inlet passage 601, a sleeve body 615, a sealing assembly including a spring washer 630 seated at the outlet, and a closure element 640 received in the washer 630 and sealing the outlet. The sprinkler 600 further includes a load screw 685, a yoke 660, two levers 670 and a soldered link 680. Each of these features operates in a similar manner to the corresponding features discussed above for sprinklers 1 and 100.

However, sprinkler 600 differs from sprinklers 1 and 100 in the structure of the deflector. In particular, sprinkler 600 includes a slide plate 635 having a center aperture for fitting over the inlet passage 601. A sub-assembly 650 including a machined frame 710 and a deflector 750 (see FIGS. 7A to 7D) are attached to the slide plate 635. The frame 710 is machined in the shape of a wishbone and has two arms being attached to the slide plate via, for example, rivets 730. A top portion of the frame 710 opposite the two arms is attached to the deflector 750. A height of the rivets 730 from the slide plate 635 is provided at reference numeral 715. The arms of the frame 710 are substantially the same size as side of the deflector 750 parallel to the arms.

In some example embodiments, the sprinkler has a length measured along the axis between the inlet and the outlet of less than, for example, 2¼-inches prior to actuation and increasing to more than 2½-inches following actuation. The sprinkler has a coverage length and a coverage width, the coverage length being oriented in a direction parallel with the longitudinal axis between the inlet orifice and the outlet orifice and the coverage length being oriented in a direction perpendicular to the axis between the inlet orifice and the outlet orifice. In these example embodiments, the coverage length is more than 18 ft. The coverage length and coverage width define a coverage area, and the sprinkler delivers fluid to a wall at the perimeter of the coverage area at a rate at not less than the flow rate of fluid through the outlet multiplied by 20 percent of the ratio between the length of the wall and the perimeter of the coverage area. In this regard, the sprinkler, prior to actuation, fits in a roughly 3½-inch deep space formed by nominal 2″ by 4″ studs in the wall.

A spring 620, for example, a conical spring is provided between the slide plate 635 and an inner wall of the sprinkler body 610 (towards the bottom of the drawing), which forces the slide plate 635 away from the sprinkler 600. Fusion of the soldered link 680 results in the release of the levers 670, and results in the levers 670, the yoke 660 and the load screw 685 being forced out of and away from the sprinkler 600 by the force of the fluid. At this time, also, the conical spring 620 forces the slide plate 635 outward from the wall (up in the drawing), and forces the frame 710 outward from the wall, moving the deflector to the proper position to deliver the fluid where it is needed. The sprinkler 600 further includes a guide pin 690 for helping to guide the slide plate 635 upon actuation of the sprinkler.

A ball 625, as shown in FIG. 6B, can be provided to act as a free spinning bearing. The ball 625 can reduce friction (torsion) during final assembly of the sprinkler, whereby screw 685 is torqued (screwed downwards) to impart deflection load to seal washer 630.

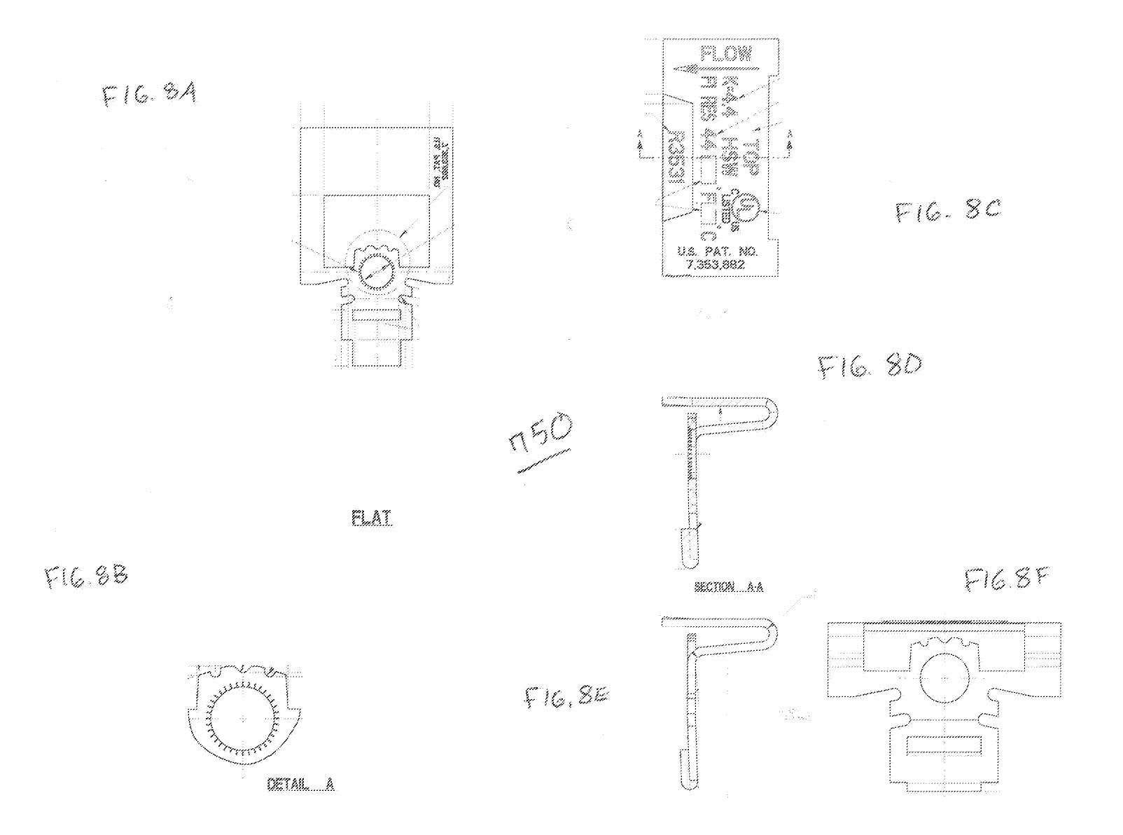

FIGS. 8A to 8F show various views of the deflector 750. The deflector 750 may if desired by identical to that used in Reliable's sprinkler described in U.S. Pat. No. 7,353,882 (incorporated by reference), although the invention is not limited to use of that deflector. The deflector may have a radically folded/pulled back back canopy (towards the sprinkler's orifice) that results in minimal overhang of the canopy over the vertical dispersion plate. This can reduce the overall length of sprinkler 600, thus allowing the sprinkler to fit within a typical 2 inch by 4 inch stud space.

The truncated frame arms 710, the load screw 685, and the deflector attachment means per Section B-B at FIG. 7D may if desired by similar to those used in Reliable's UL Listed Fl Residential Horizontal Sidewall Sprinkler (Bulletin 033, incorporated by reference), although the invention is not limited to use of the structure defined therein.

The sprinkler 600 is preferably a residential sidewall type sprinkler as defined by NFPA 13 and can have a nominal k-factor of 4.2 gpm/psi^{1/2}. The sprinkler 600 is permitted for use in residential occupancies and can obtain a coverage of 16 feet by 20 feet. Further technical details of the sprinkler 600 arc provided below in Tables 3 and 4. Of course, the invention herein is not limited by the technical details provided in these tables, which are merely examples of this embodiment.

TABLE 3

| | | | | | Maximum | Sprinkler | |
|---|---|---|---|---|---|---|---|
| | | | | Maximum | Water | Identification | |
| Orifice | “K” Factor | | Thread | Ambient | Working | Number | |
| Size | US | Metric | Size | Temperature | Pressure | (SIN) | Approvals |
| [symbol] | 4.2 | 60 | [symbol] NPT | 100° F. | 175 PSI | RA4835 | cULus |
| (9.6 mm) | | | (R [symbol] ) | (38° C.) | (12 bar) | | |

[symbol]

indicates data missing or illegible when filed

TABLE 4
Listed Design Criteria***

| Max. | | Deflector | | | | | | | |
|---|---|---|---|---|---|---|---|---|---|
| Coverage Area | | to Ceiling | | | | | | Temperature | |
| Width × Length | | Dimension | | Flow Rate | | Pressure | | Rating | |
| ft. × ft. | m × m | inches | mm | gpm | L/min | psi | bar | Sprinkler | Cover |
| 12 × 12 | 3.6 × 3.6 | 4-6 | 102-152 | 12 | 45.4 | 8.2 | 0.57 | 165° F. | 135° F. |
| 12 × 12 | 3.6 × 3.6 | 6-12 | 152-306 | 13 | 49.2 | 9.6 | 0.67 | (74° C.) | (57° C.) |
| 14 × 14 | 4.3 × 4.3 | 4-6 | 102-152 | 12 | 45.4 | 8.2 | 0.57 | | |
| 14 × 14 | 4.3 × 4.3 | 6-12 | 152-305 | 14 | 53.0 | 11.1 | 0.78 | | |
| 16 × 16 | 4.9 × 4.9 | 4-12 | 102-305 | 16 | 60.6 | 14.5 | 1.01 | | |
| 16 × 18 | 4.9 × 5.5 | 4-12 | 102-305 | 18 | 68.1 | 18.4 | 1.29 | | |
| 16 × 20 | 4.9 × 6.1 | 4-6 | 102-152 | 22 | 83.3 | 27.4 | 1.92 | | |
| 16 × 20 | 4.9 × 6.1 | 6-12 | 152-305 | 23 | 87.0 | 30.0 | 2.10 | | |

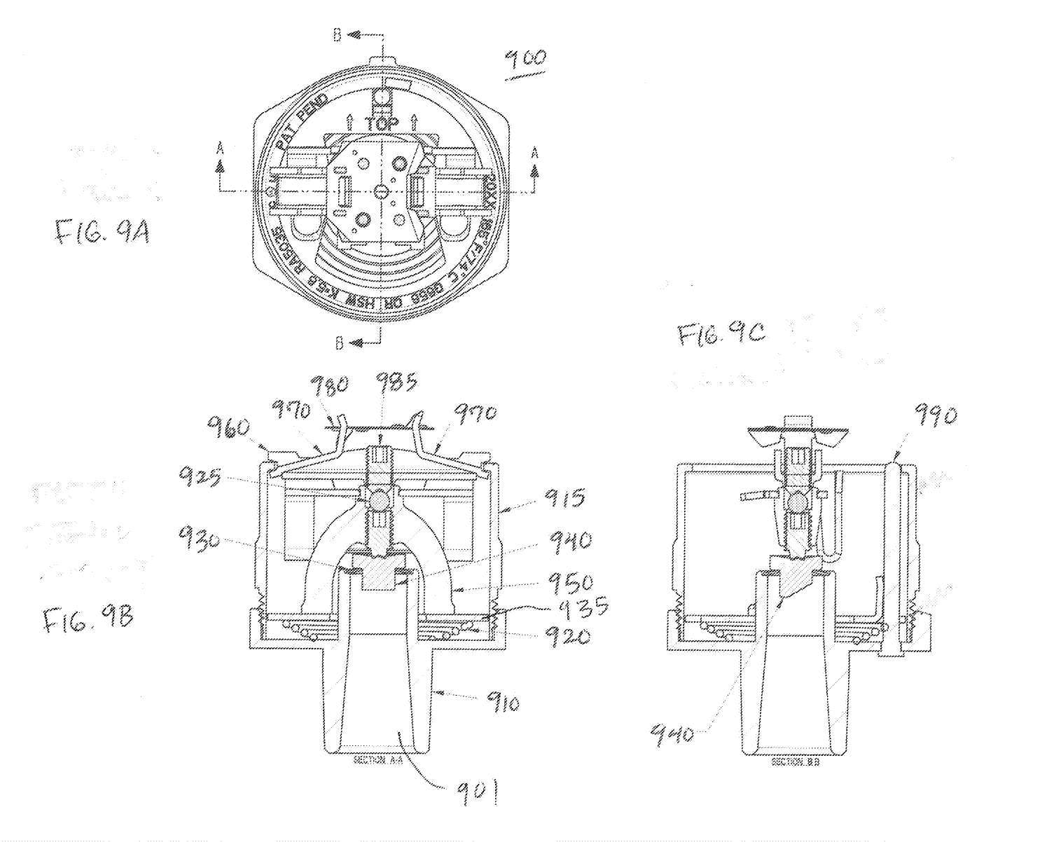

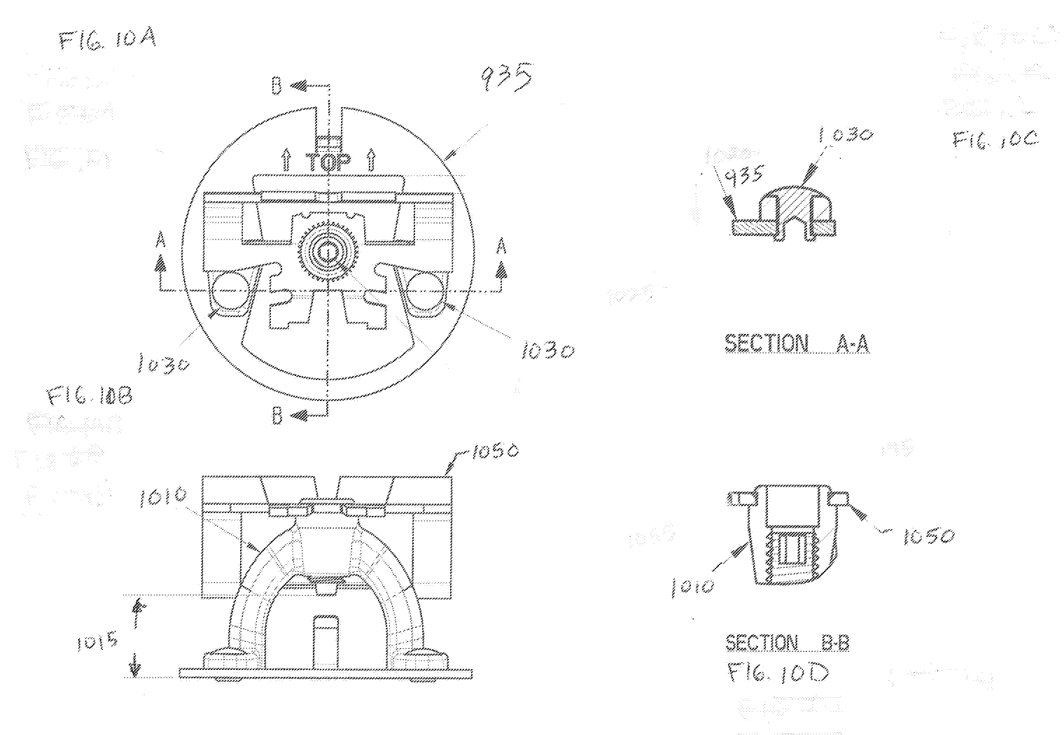

FIGS. 9A to 9C show a horizontal sidewall sprinkler 900 according to an additional example embodiment described herein. Similar to the sprinkler 600 discussed above, the sprinkler 900 includes a sprinkler body 910, an inlet passage 901, a sleeve body 915, a sealing assembly including a spring washer 930 seated at the outlet, and a closure element 940 received in the washer 930 and sealing the outlet. The sprinkler 900 further includes a load screw 985, a yoke 960, two levers 970 and a soldered link 980. Each of these features operates in a similar manner to the corresponding features discussed above for sprinklers 1 and 100.

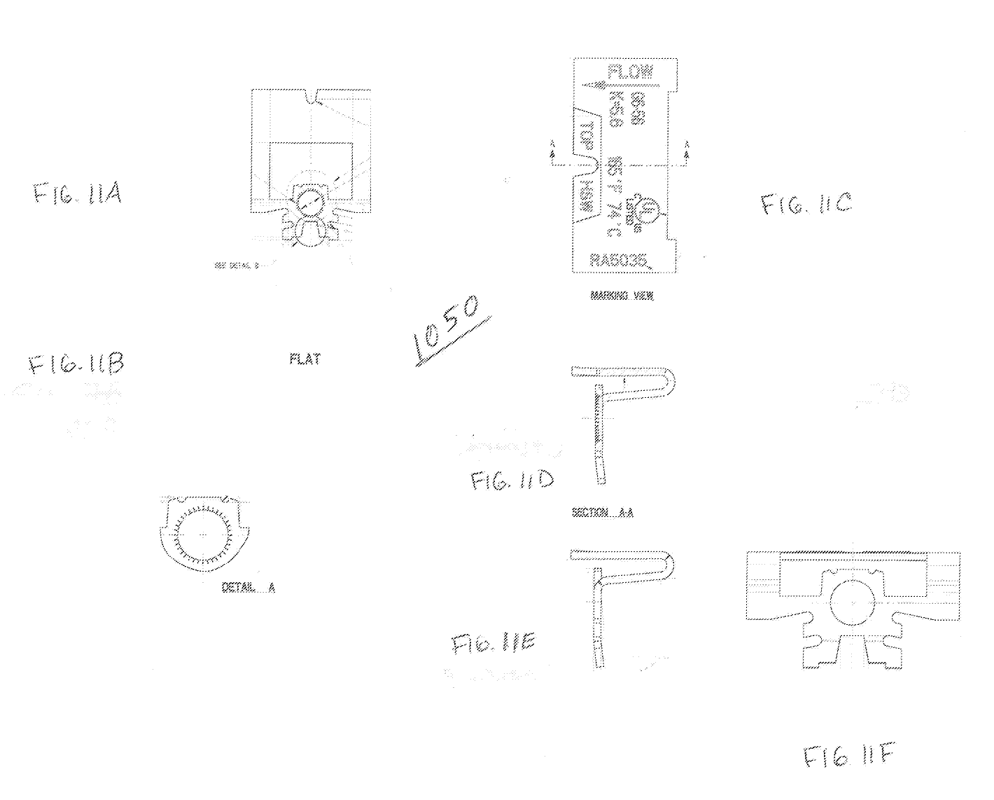

Sprinkler 900 includes a slide plate 935 having a center aperture for fitting over the inlet passage 901. A sub-assembly 950 including a machined frame 1010 and a deflector 1050 (see FIGS. 10A to 10D) are attached to the slide plate 935. The frame 1010 is machined in the shape of a wishbone and has two arms being attached to the slide plate via, for example, rivets 1030. A top portion of the frame 1010 opposite the two arms is attached to the deflector 1050. A height from the slide plate 935 to a bottom side of the deflector 1050 is provided at reference numeral 1015. Sprinkler 900 differs from sprinkler 600, in that the arms of the frame 1010 are substantially larger than the size of a side of the deflector 1050 parallel to the arms (e.g., the arms of the frame 1010 are about twice the size of the deflector 1050).

A spring 920, for example, a conical spring is provided between the slide plate 935 and an inner wall of the sprinkler body 910 (towards the bottom of the drawing), which forces the slide plate 935 away from the sprinkler 900. Fusion of the soldered link 980 results in the release of the levers 970, and results in the levers 970, the yoke 960 and the load screw 985 being forced out of and away from the sprinkler 900 by the force of the fluid. At this time, also, the conical spring 920 forces the slide plate 935 outward from the wall (up in the drawing), and forces the frame 1010 outward from the wall, moving the deflector to the proper position to deliver the fluid where it is needed. The sprinkler 900 further includes a guide pin 990 for helping to guide the slide plate 935 upon actuation of the sprinkler.

FIGS. 11A to 11F show various views of the deflector 1050. The deflector 1050 may be similar to the deflector 750 described above in connection with FIGS. 8A to 8F. However, unlike deflector 750, deflector 1050 does not have an elongated double folded lower vertical dispersion plate. The deflector 1050 has a conical slot, shown at Detail B at FIGS. 11A and 11F, and a small slot on the canopy (shown in FIG. 11C). The foregoing features of the deflector 1050 can result in an optimized water distribution pattern for 10 feet by 10 feet in ordinary hazard applications.

The sprinkler 900 is preferably a sidewall standard spray sprinkler as defined by NFPA 13, having a nominal k-factor of about 5.6 gpm/psi^{1/2} and is permitted for use in light hazard and ordinary hazard occupancies. The sprinkler 900 can obtain a standard coverage as defined by NFPA 13, which is 14 feet by 14 feet for light hazard applications and 10 feet by 10 feet for ordinary hazard applications. Further technical details of the sprinkler 900 are provided below in Tables 5 and 6. Of course, the invention herein is not limited by the technical details provided in these tables, which arc merely examples of this embodiment.

TABLE 5

| Nominal Orific | “K” Factor | | | Maximum Water |
|---|---|---|---|---|
| Size | US | Metric | Thread Size | Service Pressure |
| ½ inch (15 mm) | 5.6 | 80 | ½″ NPT (R½) | 175 PSI (12 bar) |

TABLE 6

| Sprinkler | Max. | Sprinkler | Cover Plate | |
|---|---|---|---|---|
| Identification | Ambient | Temperature | Temperature | |
| Number (SIN) | Temperature | Rating | Rating | Approval |
| RA5035 | 100° F. | 165° F. | 135° F | cULus |
| | (38° C.) | (74° C.) | (57° C.) | |

While the present disclosure has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims.

In addition, it should be understood that the attached drawings, which help to explain functionality described herein, are presented as illustrative examples. The architecture of the present disclosure is sufficiently flexible and configurable, such that it can be utilized and navigated in ways other than shown in the drawings.

Moreover, the purpose of the Abstract is to enable the U.S. Patent and Trademark Office and public generally, and especially scientists, engineers and practitioners in the relevant art(s), who are not familiar with patent or legal terms and/or phraseology, to determine quickly from a cursory inspection the nature and essence of the technical subject matter disclosed herein. The Abstract is not intended to be limiting as to the scope of the present disclosure in any way. It is also to be understood that the procedures recited in the claims need not be performed in the order presented.

What is claimed is:

1. A horizontal sidewall sprinkler comprising:
a sprinkler body having an inlet passage for supply of a fluid and an outlet, the outlet being closed by a sealing assembly prior to actuation of the sprinkler;
a sleeve body secured to the sprinkler body;
a yoke substantially spanning a width of the sleeve body, the yoke urging a load screw against a surface of the sealing assembly facing an occupancy, and being held in place prior to actuation of the sprinkler by two levers that are joined by a soldered link;
a slide plate located near an inner wall of the sprinkler body facing the occupancy prior to actuation of the sprinkler, the slide plate having a central aperture for fitting over the inlet passage;
a frame or two guide pins for bearing and supporting a deflector, wherein the deflector is positioned between the load screw and the sealing assembly thereby obstructing a flow of fluid from the outlet upon actuation of the sprinkler; and
a spring provided in the sprinkler body, between the inner wall of the sprinkler body and pressing (1) the slide plate and (2) the frame or the two guide pins away from the inner wall,
wherein upon actuation of the sprinkler, the levers, the yoke and the load screw are forced out of and away from the sprinkler by the force of the fluid, the spring forces the slide plate outward from the inner wall, and the force of the fluid moves the deflector away from the slide plate to a position for delivery of the fluid to the protected area.

2. The horizontal sidewall sprinkler of claim 1, wherein the slide plate has two additional apertures receiving towers, each tower housing one of the two guide pins, and wherein the spring further forces the guide pins to extend from the towers after actuation of the sprinkler.

3. The horizontal sidewall sprinkler of claim 1, wherein the scaling assembly comprises a spring washer seated at the outlet, and a closure element received in the washer and sealing the outlet, wherein the seal is kept closed prior to actuation of the sprinkler.

4. The horizontal sidewall sprinkler of claim 3, wherein the closure element has an oblique lower surface in part.

5. The horizontal sidewall sprinkler of claim 1, wherein the yoke is self-centering and self-seating on a retaining flange of the sleeve body, having terraced tabs on both ends of the yoke, wherein a top one of the tabs serves as a vertical seating medium, a middle one of the tabs serves as a horizontal centering medium with the inner diameter of the flange, and a bottom one of the tabs serves as a load bearing medium for the soldered link levers.

6. The horizontal sidewall sprinkler of claim 1, further comprising a diffuser including a convex solid portion located with its center on an axis of fluid passage in the sprinkler body, wherein prior to actuation of the sprinkler the diffuser transmits the force from the load screw to the seal assembly, and upon actuation of the sprinkler, the fluid strikes the convex solid portion of the diffuser.

7. The horizontal sidewall sprinkler of claim 6, wherein the diffuser comprises a horizontally extending upper planar portion extending above the axis of the fluid passage, and the fluid passes through the diffuser through an aperture provided above the convex portion and below the upper planar portion.

8. The horizontal sidewall sprinkler of claim 7, wherein the diffuser further comprises additional apertures provided in a vertical portion of the deflector provided downstream from the convex portion.

9. The horizontal sidewall sprinkler of claim 1, wherein the frame is wishbone shaped having two arms being attached to the slide plate, and a top portion of the frame opposite the two arms is attached to the deflector.

10. The horizontal sidewall sprinkler of claim 9, wherein the arms of the frame are substantially the same size as side of the deflector parallel to the arms.

11. The horizontal sidewall sprinkler of claim 10, wherein the sprinkler, prior to actuation, fits in a roughly 3½-inch deep space formed by nominal 2-inch by 4-inch studs in the wall.

12. The horizontal sidewall sprinkler of claim 1, wherein a type of the sprinkler is a residential sidewall sprinkler, a sidewall standard spray sprinkler, or an extended coverage sidewall spray sprinkler.

13. The horizontal sidewall sprinkler of claim 1, wherein the occupancy is a residential occupancy, a light hazard occupancy, or an ordinary hazard occupancy.

14. The horizontal sidewall sprinkler of claim 1, wherein a nominal K-factor of the sprinkler is about 4.2 gpm/psi^{1/2}, 5.6 gpm/psi^{1/2}, or 8.0 gpm/psi^{1/2}.

15. The horizontal sidewall sprinkler of claim 1, wherein the sprinkler provides a coverage area of equal to or greater than 8 feet by 8 feet and up to and including 16 feet by 20 feet.

16. The horizontal sidewall sprinkler of claim 1, wherein the sprinkler provides a coverage area of equal to or greater than 8 feet by 8 feet and up to and including 18 feet by 22 feet.

17. The horizontal sidewall sprinkler of claim 1, wherein the sprinkler provides a coverage area of equal to or greater than 8 feet by 8 feet and up to and including 16 feet by 24 feet.

18. The horizontal sidewall sprinkler of claim 1, wherein a minimum flow rate of the sprinkler is at least 12 gpm.

19. The horizontal sidewall sprinkler of claim 1, wherein a minimum flow rate of the sprinkler is at least 26 gpm.

20. The horizontal sidewall sprinkler of claim 1, wherein a minimum pressure of the sprinkler is at least 8.2 psi.

21. The horizontal sidewall sprinkler of claim 1, wherein a minimum pressure of the sprinkler is at least 10.6 psi.

22. The horizontal sidewall sprinkler of claim 1, wherein the fluid pressure on the sprinkler is 175 psi or less.

23. A horizontal sidewall sprinkler assembly comprising:
a sprinkler body having a proximal end and a distal end;
the proximal end of the sprinkler body having threads for connection to a fluid supply conduit and an inlet passage through which fluid can enter the sprinkler from the fluid supply conduit;
the distal end of the sprinkler body having an outlet;
a scaling assembly which closes the outlet prior to actuation of the sprinkler,
the sealing assembly being releasably held in place prior to actuation by a temperature-sensitive element;
the sprinkler having a length measured along the axis between the inlet and the outlet of less than 2¼-inches prior to actuation and increasing to more than 2½-inches following actuation;
the sprinkler having a coverage length and a coverage width, the coverage length being oriented in a direction parallel with the longitudinal axis between the inlet orifice and the outlet orifice and the coverage length being oriented in a direction perpendicular to the axis between the inlet orifice and the outlet orifice;
the coverage length being more than 18 feet;
the coverage length and coverage width defining a coverage area;
the sprinkler delivering fluid to a wall at the perimeter of the coverage area at a rate at not less than the flow rate of fluid through the outlet multiplied by 20 percent of the ratio between the length of the wall and the perimeter of the coverage area.

24. The horizontal sidewall sprinkler of claim 23, wherein the sprinkler is a residential sprinkler meeting the requirements of Underwriters' Laboratories Standard 1626.

25. The horizontal sidewall sprinkler of claim 23, wherein the minimum flow rate is equal to or less than 23 gpm.

26. The horizontal sidewall sprinkler of claim 23, wherein the fluid pressure on the sprinkler is 175 psi or less.
